(19) United States
(12) Patent Application Publication
(10) Pub. No.: US 2004/0237081 A1
(43) Pub. Date: Nov. 25, 2004

(54) Methods and apparatus for generating upgraded software from initial software and software upgrade packages

(76) Inventor: Daniel P. Homiller, Cary, NC (US)

Correspondence Address: MYERS BIGEL SIBLEY & SAJOVEC, PO BOX 37428, RALEIGH, NC, 27627, US

(21) Appl. No.: 10/440,910

(22) Filed: May 19, 2003

(51) Int. Cl. G06F 9/44; G06F 9/445

(52) U.S. Cl. 717/170; 717/178

(57) ABSTRACT

Methods and apparatus are provided for upgrading software in wireless terminals. An initial version of software is provided in at least one memory in a wireless terminal. A software upgrade package is transferred into the at least one memory by a manufacturer of the wireless terminal. An upgraded version of software is generated in the wireless terminal from the initial version of software and the software upgrade package. The wireless terminal may then be operated according to the upgraded version of software.

### BACKGROUND OF THE INVENTION

The present invention relates to wireless terminals that operate according to internally stored software and, more particularly, to methods for upgrading software in wireless terminals, such as cellular radiotelephones.

Consumer wireless terminals, such as cellular terminals, are generally preprogrammed with software in a non-volatile memory (in which case the software is often called firmware) before they are shipped by a manufacturer. For cellular terminals, the software generally defines a wireless communication protocol, an operating system, and applications such as games, phone book, and email. The software may be loaded into the non-volatile memory before the memory is installed in the cellular terminal, or the software may be loaded afterwards, such as during a testing phase of a manufacturing process. For example, test software may be loaded into the cellular terminal to support testing and, when the cellular terminal passes the testing, operational software may then be loaded.

Manufacturers frequently seek to provide users added features to expand the utility of the wireless terminals, or to remedy potential or actual problems with the operation of the devices. In many such instances, it may be necessary to upgrade the software in the device by loading upgraded software as a substitute for pre-loaded software. Sometimes, the upgrade can be performed during manufacturing, prior to packaging and delivery. However, sometimes it may be necessary to upgrade the software while the device is in the manufacturer's inventory, in distribution facilities, or in a wholesale customers' inventory. Sometimes, upgrading software necessitates unpacking the consumer wireless terminals, re-programming the software, verifying the software, and repacking the devices.

Loading software into a non-volatile memory may take a significant amount of time due to, for example, the long write cycle times and associated slow write operations with many non-volatile memories (e.g., EEPROMS and Flash-EEPROMS). For example, it can take 3 to 12 minutes to load software into a cellular terminal. The amount of time that is required to complete a software upgrade effort can be a major component of the resulting cost of the effort. Upgrading software can become very expensive when it is necessary to load software into thousands, or even hundreds of thousands of consumer wireless terminals.

Some approaches for reducing the cost of upgrading software include reducing the software loading time by using non-volatile memories having faster write cycles and/or using faster data connections between a software programmer and the consumer devices. Some other approaches include using software programming devices that are capable of simultaneously upgrading the software in many wireless terminals.

### SUMMARY OF THE INVENTION

Embodiments of the present invention provide a method of upgrading software in a wireless terminal. An initial version of software is provided in at least one memory in the wireless terminal. A software upgrade package is then transferred into memory by a manufacturer of the wireless terminal. An upgraded version of software is then generated in the wireless terminal from the initial version of software and the software upgrade package in response to a predetermined event that occurs with use of the wireless terminal by an end user, and the upgraded version of software is stored in the wireless terminal memory. The wireless terminal may then be operated according to the upgraded version of software.

In this manner, a manufacturer may load an initial version of software into the wireless terminal. When the manufacturer desires to upgrade (i.e., modify) the initial version of software, a software upgrade package may be generated and loaded into the wireless terminal. The software upgrade package may contain instructions and data that may be used by the wireless terminal to generate an upgraded version of software within the wireless terminal from the initial version of software and the software upgrade package. The software upgrade package may be substantially smaller than the initial version of software, and may therefore be loaded into the wireless terminal in substantially less time than may be needed to load the initial version of software.

The generation of the upgraded version of software within the wireless terminal is delayed until the occurrence of a later predetermined event that occurs with use of the wireless terminal by an end user. Accordingly, a portion of the time that is needed for upgrading the software in the wireless terminal, and possibly a majority of the total upgrade time, may be shifted away from the manufacturer.

### BRIEF DESCRIPTION OF THE DRAWINGS

FIG. 1 is a schematic block diagram illustrating a software download manager, a wireless terminal, and a wireless network according to some embodiments of the present invention.

FIG. 2 is a schematic block diagram of a software upgrade generator according to embodiments of the present invention.

FIG. 3 is a schematic block diagram of the processor of FIG. 1 according to embodiments of the present invention.

FIG. 4 is a flow chart illustrating operations for generating an upgraded version of software according to embodiments of the present invention.

### DETAILED DESCRIPTION

The present invention now will be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

It also will be understood that, as used herein, the term “comprising” or “comprises” is open-ended, and includes one or more stated elements, steps and/or functions without precluding one or more unstated elements, steps and/or functions.

The present invention is described below with reference to block diagrams and/or operational illustrations of methods and wireless terminals according to embodiments of the invention. It is understood that each block of the block diagrams and/or operational illustrations, and combinations of blocks in the block diagrams and/or operational illustrations, can be implemented by radio frequency, analog and/or digital hardware, and/or computer program instructions. These computer program instructions may be provided to a processor of a general purpose computer, special purpose computer, ASIC, and/or other programmable data processing apparatus in a wireless terminal, such that the instructions, which execute via the processor of the computer and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

It should be understood, that, as used herein, the term “wireless terminal” may include a cellular radiotelephone with or without a multi-line display; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, organizer, calendar and/or a global positioning system (GPS) receiver; and a conventional laptop and/or palmtop portable computer that includes a radiotelephone transceiver.

It should be also be understood, that as used herein, the term “memory” may refer to one or more physical units or to more than one type of physical memory. A wireless terminal may contain several types of memory, including RAM and non-volatile memory, and each type of memory may further be divided into more than one physical unit. Some or all of the RAM, for example, may actually be located on the same integrated circuit as the processor. Likewise, any of the processing functions described herein may in fact be performed by a combination of processors, so the term “processor” as used herein refers to at least one processor.

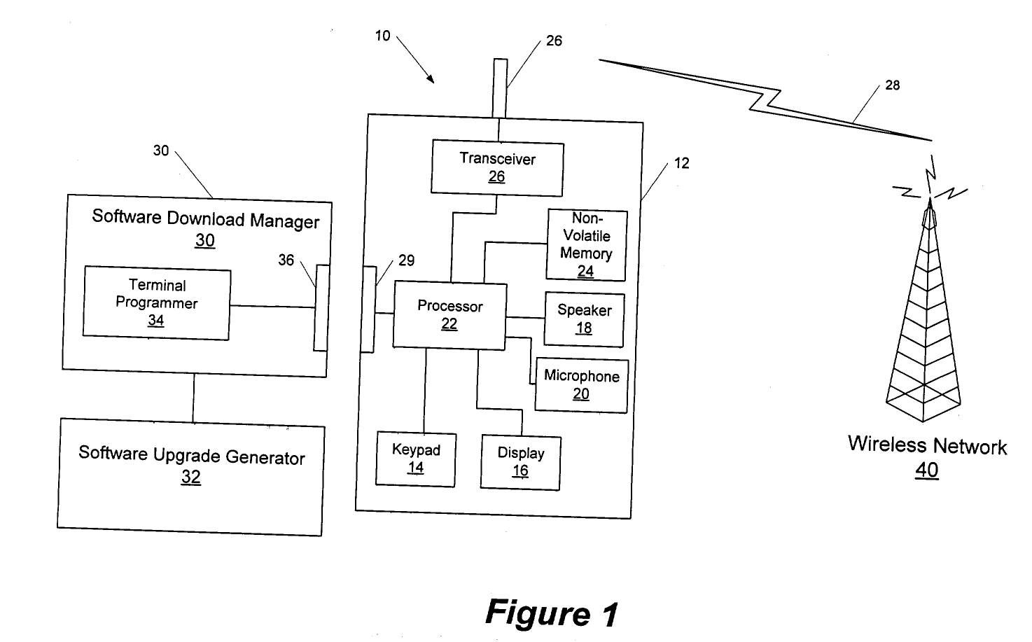

Various embodiments of the present invention will now be described with reference to the schematic block diagram of FIG. 1 that illustrates an exemplary wireless communication system that includes a wireless terminal 10, a software upgrade generator 32, a software download manager 30, and a wireless communications network 40.

Using the software download manager 30, a manufacturer may load an initial version of software into the wireless terminal 10. When the manufacturer desires to upgrade (i.e., modify) the initial version of software, a software upgrade package is generated by the software upgrade generator 32, and loaded into the wireless terminal 10 via the download manager 30. This loading of the software upgrade package into the wireless terminal 10 may be performed using the same download manager 30 as was used for loading the initial version, or by another system of equivalent functionality. The software upgrade package may contain instructions and data that may be used by the wireless terminal 10 to generate an upgraded version of software within the wireless terminal 10 from the initial version of software and the software upgrade package. The software upgrade package may be substantially smaller than the initial version of software, and may therefore be loaded into the wireless terminal 10 in substantially less time than was needed to load the initial version of software.

The generation of the upgraded version of software within the wireless terminal 10 may then be delayed until the occurrence of a latter predefined event that occurs with use of the wireless terminal 10 by an end user (i.e., customer). For example, the predefined event may occur after the wireless terminal 10 is sold to an end user, taken out of its packaging, and initially used. Alternatively, a signal may be transmitted to the wireless terminal 10 from the wireless network 40 to trigger the generation of the upgraded version of software within the wireless terminal 10. Accordingly, a portion of the time that is needed for upgrading the software in the wireless terminal 10, and possibly a majority of the total upgrade time, may be shifted away from the manufacturer. The time savings, and the associated cost savings, can be substantial for the manufacturer, for example, when the wireless terminals 10 are manufactured in high volumes.

The, software download manager 30, the software upgrade generator 32, the wireless terminal 10, and the predefined events that cause the generation of the upgraded version of software in the wireless terminal 10 will now be described in further detail for some embodiments of the present invention.

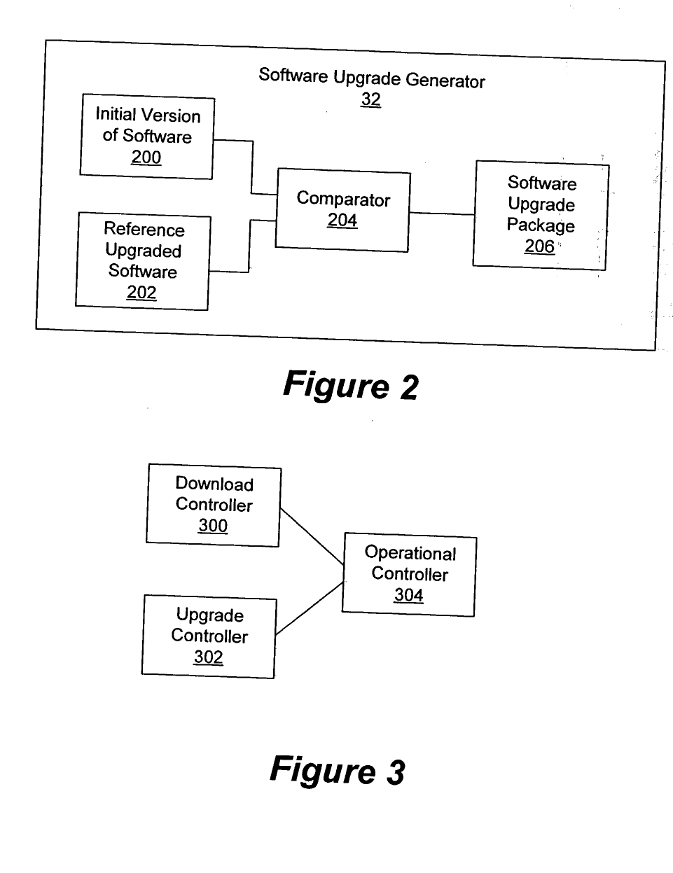

As illustrated in FIG. 1, the software download manager 30 may load an initial version of software into the wireless terminal 10 using a terminal programmer 34 that can be communicatively coupled through an electrical interface 36 to an electrical interface 29 in the wireless terminal 10. In some other embodiments of the present invention, the software download manager 30 may include a wireless transmitter that is configured to transmit the software through a wireless interface, for example through the wireless network 40, to the wireless terminal 10. Alternative methods for transmitting the software between the software download manager 30 and the wireless terminal 10 include infrared communications and short-range wireless communications (e.g. wireless LAN or Bluetooth). Referring also to FIG. 2, when the manufacturer desires to upgrade (i.e., change) the software in the wireless terminal 10, a software upgrade generator 32 may be used to generate a software upgrade package from an initial version of software 200 and a reference upgraded software 202. The initial version of software 200 may be the software that is, or will be, initially loaded into the wireless terminal 10, and the reference upgraded software 202 may be the desired upgraded software. A comparator 204 compares differences between the initial version of software 200 and the reference upgraded software 202, and generates a software upgrade package 206. Various algorithms embodied in the comparator 204 are well known and will not be further described herein.

The software upgrade package 206 may contain instructions and data that may be used by the wireless terminal 10 to generate an upgraded version of software within the wireless terminal 10 from the initial version of software 200 and the software upgrade package 206. The software download manager 30 may then be used to load the software upgrade package 206 into the wireless terminal 10. The software upgrade package 206 may be substantially smaller than the initial version of software, and may therefore be loaded into the wireless terminal 10 in substantially less time than would be needed to load the reference upgraded software 202. Accordingly, the time needed to upgrade the software in the wireless terminal 10, and associated cost of the upgrade, may be reduced by loading the software upgrade package 206 instead of the reference upgraded software 202.

As illustrated in FIG. 1, the wireless terminal 10 may include a portable housing 12, a keyboard/keypad 14, a display 16, a speaker 18, and a microphone 20. The wireless terminal 10 also includes a processor 22 and at least one non-volatile memory 24, and may include a transceiver 26. The non-volatile memory 24 may include one or more erasable programmable read-only memories (EPROM or Flash EPROM), battery-backed random access memory (RAM), magnetic, optical, or other digital storage device, and may be separate from, or at least partially within, the processor 22. The transceiver 24 typically includes both a transmitter and a receiver to allow two way communications, but the present invention is not limited to such devices and, as used herein, a “transceiver” may include both a receiver and a transmitter or only one such communication circuit. The wireless terminal 10 may, thereby, communicate with the wireless communications network 40 using radio frequency signals. The radio frequency signals may be communicated through an antenna 26 over at least one communication channel 28 with the wireless communications network 40.

The processor 22 may support various communication and application related functions of the wireless terminal 10 that are defined by the software in the memory 24. Operating according to the software, the processor 22 may format communication signals for transmission over the communication channel 28 according to a wireless communication protocol and may interpret formatted communication signals received over the communication channel. (The term “communication channel” is used herein in a broad sense, transmission and reception may actually occur over the same or separate logical or physical channels.) The wireless communication protocol may include operations for establishing the communication channel 28 as a communication connection with the wireless network 40, maintaining the communication connection, formatting voice (speech) signals from the microphone 20 to digital communication signals that are suitable for transmission over the communication channel 28 (i.e., voice coding), and/or formatting voice signals that are received over the communication channel 28 to a form suitable for output by the speaker 18 (i.e., voice decoding). The formatted communication signals may include both traffic. (voice and/or data) and control signals (e.g., paging signals/messages for incoming calls). Examples of wireless communication protocols for use with embodiments of the present invention include, ANSI-136, GSM, code division multiple access (CDMA), wideband-CDMA, CDMA2000, Enhanced Data rates for GSM Evolution (EDGE), Universal Mobile Telecommunications System (UMTS), Bluetooth, and wireless local area network (WLAN) protocols, including IEEE 802.11b, and the like. These and other wireless communication protocols are well known to those of skill in the art and will not be further described herein.

The software may also define operations for providing games to a user, playing music (e.g., mp3 or other formatted music), accessing a phone book that is internal to the wireless terminal 10, and/or for generating, receiving, and/or displaying on the display 16 short message service messages, emails, data, digital pictures, and/or video.

As illustrated in FIG. 3, the processor 22 may include a download controller 300, an upgrade controller 302, and an operational controller 304. The controllers 300, 302, and 304 may be separate circuits or may share at least some, or all, common circuitry, and/or may be instructions that are provided to a general purpose computer, special purpose computer, ASIC, and/or other programmable data processing apparatus. The download controller 300 may be configured to load (i.e. receive) the initial version of software and/or the software upgrade package from the electrical interface 29 to the non-volatile memory 24. The software upgrade package may be loaded into the same memory as the initial version of software and/or a separate memory.

In other embodiments of the present invention, the initial version of software and/or the software upgrade package may be loaded into the non-volatile memory 24 before it is assembled in the wireless terminal 10. In still other embodiments of the present invention, the download controller 300 may be configured to receive the initial version of software and/or the software upgrade package, via the antenna 26 and transceiver 24, from the wireless network 40 over the communication channel 28, and to load the received software into the non-volatile memory 24.

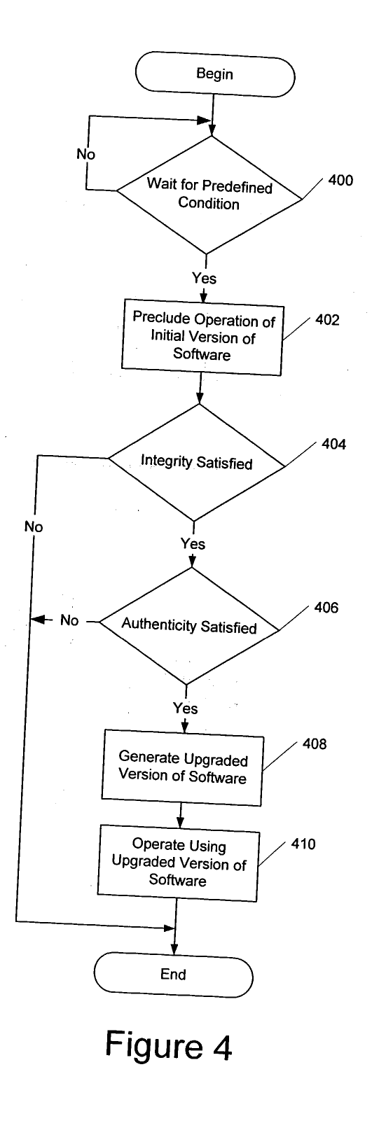

The upgrade controller 302 may be configured to generate an upgraded version of software from the initial version of software and the software upgrade package. In some embodiments of the present invention, the upgrade controller 302 may follow the operations that are illustrated in FIG. 4 to generate an upgraded version of software. With reference to FIG. 4 at Block 400, the generation of an upgraded version of software is delayed until after the occurrence of a predefined condition.

The predefined condition may be when the wireless terminal 10 is first connected to a power source, such as a battery and/or an external power source, after it has been earlier loaded with the initial version of software and the software upgrade package and then disconnected from a power source. Typically, a user is instructed by the manufacturer (via a manual provided with the wireless terminal) to connect a battery to wireless terminal 10, and to fully charge the battery before using the wireless terminal 10. Connection of the battery and/or an external power source to the wireless terminal 10 may initiate the generation of an upgraded version of software when a software upgrade package is present.

The predefined condition may be responsive to an initial setup of the wireless terminal 10. For example, the wireless terminal 10 may initiate the generation of an upgraded version of software when it attempts to register and/or become activated with the wireless network 40 according to a wireless communication protocol that is defined by the initial version of software. The operations for activating a cellular wireless terminal for use with a home cellular network and for registering a cellular wireless terminal with a cellular network are well known and will not be further described herein. In another example, the initial setup of the wireless terminal 10 may be operations that are performed by the wireless terminal 10 before a first use by a user.

The generation of an upgraded version of software may be responsive to an upgrade command that is received from the wireless network 40 over the communication channel 28. The wireless network 40 may communicate the upgrade command to wireless terminals based on their attempt to be activated and/or to register with the wireless network 40. The wireless network 40 may first determine an identity of a wireless terminal, such as its serial number, model number, and/or manufacturer, and may further identify a version or other indication of the type of software used by the wireless terminal. The wireless terminal 40 may then use the information to determine whether a software upgrade is desired and to command the wireless terminal to upgrade its software.

At Block 402, after the predefined condition is satisfied at Block 400, further 20:1 operation of the wireless terminal using the initial version of software may be precluded or stopped while an upgraded version of software is generated. Because the upgraded version of software may at least partially replace the initial version of software in the memory 24 during the upgrade, the memory 24 may contain an incomplete combination of the initial and upgraded versions of software. If the wireless terminal 10 were to operate according to such an incomplete combination, incorrectly formatted communication signals or other incorrect operation may result.

Accordingly, it may be advantageous for the wireless terminal 10 to at least preclude/stop formatting communication signals using the initial version of software until the completion of the generation of the upgraded version of software in the memory 24.

If the wireless terminal 10 is “ON” prior to an imminent software upgrade, or during a software upgrade, a message may be displayed to a user, such as “Configuring Phone Software”, to alert the user that operation of the wireless terminal is precluded. The user may alternatively be permitted to start a software upgrade, schedule the start of a software upgrade for a latter time or other predefined event, and/or decline a software upgrade.

At Block 404, the integrity of the software upgrade package may be verified, for example, by performing a parity check on the software, or by another operation, to check for errors. At Block 406, the authenticity of the software upgrade package may be verified. The determination of authenticity may prevent the use of a software upgrade package that is intended for a different type of wireless terminal, and/or prevent the use of software that has been developed, or modified, by a non-authorized individual or entity. The determination of authenticity may be responsive to a comparison of information, such as an authorization key, with an authentication code in the wireless terminal 10. The authorization key and/or authentication code may include a digital signature or pattern, sequence of patterns, and/or a computational result. The key or code may indicate a software version and/or source of the software, a manufacturer of the wireless terminal 10, a model type (e.g., product model number or product family identify), and/or may uniquely identify the wireless terminal 10 (e.g., terminal identification number or serial number). The determination of authenticity may include the use of a decryption algorithm such as the well known RSA or SHA-1 algorithms. The authorization key and/or authentication code may be received from a user of the wireless terminal 10, or may be received over the communication channel 28 from the wireless network 40, or may be separately stored within the initial version of software and the software upgrade package in the wireless terminal 10.

When the software upgrade package satisfies the integrity and authenticity verification at Blocks 404 and 406, then at Block 408 an upgraded version of software is generated from the initial version of software and the software upgrade package. The software upgrade package may include instructions and/or data that are used to transform the initial version of software into the upgraded version of software. To conserve memory space, the upgraded version of software may be stored in the non-volatile memory 24 overwriting at least a portion of the initial version of software. However, to facilitate a revision to the initial version of software, for example if the generation of the upgraded software does not properly complete or otherwise does not satisfy an integrity verification, the upgraded software may be separately stored from the initial version of software. Alternatively, the software upgrade package may contain instructions and/or data for transforming upgraded software back to the initial version of software to facilitate such reversion.

At Block 410, operation of the wireless terminal 10 is provided, at least in part, by the upgraded version of software. The upgraded version of software may define a wireless communication protocol that is used by the wireless terminal to format signals communicated with the wireless network 40, and/or may define new or modified applications that may be used by the wireless terminal 10.

Accordingly, software in a wireless terminal may be upgraded using an initial version of software and a software upgrade package. The software upgrade package may be substantially smaller than the initial version of software, and may, therefore, be loaded into the wireless terminal in substantially less time than may be needed to load the initial version of software. The software upgrade may then be delayed until the occurrence of a latter predefined event with the use of the wireless terminal by an end user. The predefined event may occur, for example, after the wireless terminal has been sold to an end-customer. Accordingly, a portion of the time that is needed for upgrading the software in the wireless terminal, and possibly a majority of the total upgrade time, may be shifted away from the manufacturer. The time savings, and associated cost savings, can be substantial for the manufacturer where the wireless terminals are manufactured in high volumes.

In the drawings and specification, there have been disclosed typical illustrative embodiments of the invention and, although specific terms are employed, they are used in a generic and descriptive sense only and not for purposes of limitation, the scope of the invention being set forth in the following claims.

That which is claimed is:

1. A method of upgrading software in a wireless terminal, the method comprising the steps of:
providing an initial version of software in at least one memory in the wireless terminal; then
transferring a software upgrade package into the at least one memory by a manufacturer of the wireless terminal; then
generating an upgraded version of software in the wireless terminal from the initial version of software and the software upgrade package in response to a predetermined event that occurs with use of the wireless terminal by an end user; and
operating the wireless terminal according to the upgraded version of software.

2. The method of claim 1, wherein generating an upgraded version of software in the wireless terminal is in response to an initial setup of the wireless terminal.

3. The method of claim 1, wherein generating an upgraded version of software in the wireless terminal is in response to an attempt by the wireless terminal to register with a wireless network over at least one wireless communication channel.

4. The method of claim 3, further comprising registering the wireless terminal over the at least one wireless communication channel with the wireless network according to a wireless communication protocol defined by the initial version of software, and wherein registering the wireless terminal follows transferring a software upgrade package and precedes generating an upgraded version of software.

5. The method of claim 4, wherein generating an upgraded version of software in the wireless terminal is in response to receiving a command from the wireless network over the at least one wireless communication channel.

6. The method of claim 1, wherein operating the wireless terminal comprises formatting communication signals according to a wireless communication protocol defined by the upgraded version of software

7. The method of claim 6, further comprising precluding formatting of communication signals during the step of generating an upgraded version of software.

8. The method of claim 1, further comprising supplying power to the wireless terminal from a removable battery, and wherein the step of generating an upgraded version of software in the wireless terminal is in response to supplying power to the wireless terminal from a removable battery.

9. The method of claim 1, further comprising determining whether the software upgrade package contains errors, and wherein generating an upgraded version of software in the wireless terminal is based on the determination of whether the software upgrade package contains errors.

10. The method of claim 1, further comprising determining whether the software upgrade package is authentic, and wherein generating an upgraded version of software in the wireless terminal is based on the determination of whether the software upgrade package is authentic.

11. The method of claim 10, wherein determining whether the software upgrade package is authentic comprises receiving an authorization key from a user, and comparing the authorization key to an authentication code in the wireless terminal.

12. The method of claim 10, wherein determining whether the software upgrade package is authentic comprises comparing an authentication key in the software upgrade package with a authentication code in the wireless terminal.

13. The method of claim 12, wherein the authentication key uniquely identifies the wireless terminal.

14. The method of claim 12, wherein the authentication key uniquely identifies a manufacturer of the software upgrade package.

15. The method of claim 10, wherein determining whether the software upgrade package is authentic comprises decrypting the software upgrade package.

16. The method of claim 1, further comprising generating the software upgrade package outside of the wireless terminal from a comparison of the initial version of software and a reference upgraded version of software.

17. The method of claim 16, wherein generating an upgraded version of software comprises transforming the initial version of software into the upgraded version of software according to instructions in the software upgrade package.

18. The method of claim 1, further comprising:
generating in the wireless terminal an indication to a user of the availability of an upgraded version of software in the wireless terminal, and wherein generating an upgraded version of software is in response to an instruction from a user.

19. A wireless terminal comprising:
at least one memory containing an initial version of software;
a download controller that is configured to transfer a software upgrade package into the at least one memory;
an upgrade controller that is configured to generate an upgraded version of software in the at least one memory from the initial version of software and the software upgrade package in response to a predetermined event that occurs with use of the wireless terminal by an end user; and
an operational controller that is configured to operate the wireless terminal according to the upgraded version of software.

20. The wireless terminal of claim 19, wherein the upgrade controller is further configured to generate the upgraded version of software in response to an initial setup of the wireless terminal.

21. The wireless terminal of claim 19, wherein:
the operational controller is further configured to register the wireless terminal over at least one wireless communication channel with a wireless network; and
the upgrade controller is further configured to generate the upgraded version of software in response to an attempt by the wireless terminal to register with a wireless network over the at least one wireless communication channel.

22. The wireless terminal of claim 21, wherein the upgrade controller is further configured to generate the upgraded version of software in response to a command from the wireless network system.

23. The wireless terminal of claim 19, wherein the operational controller is further configured to format communication signals according to a wireless communication protocol defined by the upgraded version of software.

24. The wireless terminal of claim 19, wherein the upgrade controller is further configured to generate the upgraded version of software in response to receiving power from a removable battery.

25. The wireless terminal of claim 19, wherein the upgrade controller is further configured to determine whether the software upgrade package contains errors, and to generate the upgraded version of software based on whether the software upgrade package contains errors.

26. The wireless terminal of claim 19, wherein the upgrade controller is further configured to determine whether the software upgrade package is authentic, and to generate the upgraded version of software based on whether the software upgrade package is authentic.

27. The wireless terminal of claim 19, wherein the upgrade controller is farther configured to transform the initial version of software into the upgraded version of software according to instructions in the software upgrade package.

28. A wireless terminal comprising:
at least one memory containing an initial version of software;
means for transferring a software upgrade package into the at least one memory;
means for generating an upgraded version of software in the at least one memory from the initial version of software and the software upgrade package in response to a predetermined event that occurs with use of the wireless terminal by an end user; and
means for operating the wireless terminal according to the upgraded version of software.
